(19) United States
(12) Patent Application Publication
(10) Pub. No.: US 2009/0201169 A1
(43) Pub. Date: Aug. 13, 2009

(54) Real-Time Location Systems and Methods

(75) Inventors: Loek d'Hont, Port Charlotte, FL (US); Swanson Rick, Plano, TX (US); Bernard Barink, McKinney, TX (US); Alastair Malarky, Petersburg (CA); Japjeev Kohli, Waterloo (CA); Richard Turnock, Toronto (CA)

Correspondence Address: HANLEY, FLIGHT & ZIMMERMAN, LLC, 150 S. WACKER DRIVE, SUITE 2100, CHICAGO, IL, 60606, US

(73) Assignee: MARK IV INDUSTRIES CORP., Mississauga (CA)

(21) Appl. No.: 12/367,298

(22) Filed: Feb. 6, 2009

Related U.S. Application Data
(60) Provisional application No. 61/026,917, filed on Feb. 7, 2008.

(51) Int. Cl. G08B 5/22

(52) U.S. Cl. 340/825.49

(57) ABSTRACT

A real-time location system for identifying and locating tagged items. The system may include an identification protocol that tracks in-network transponders and assigns dynamic in-network identification numbers to in-network transponders. The system includes a locator function that employs time-of-arrival analysis. Rather than attempt to synchronize the time base at each reader, the system and process eliminate the need to sync the readers and also eliminate the impact of differential receive delays in the respective readers. Both the transponder and a master reader transmit locate signals, which are measured at slave readers. The system relies on differences in time-of-arrival of the two signals at the respective slave readers to determine the likely location of the transponder.

### CROSS-REFERENCE TO RELATED APPLICATIONS

The present application claims priority to U.S. Provisional Ser. No. 61/026,917, filed Feb. 7, 2008, the contents of which are hereby incorporated by reference.

### FIELD OF THE INVENTION

The present invention relates to real-time location systems and methods employing radio frequency transponders and readers.

### BACKGROUND OF THE INVENTION

Inventory tracking is a common application for radio frequency identification systems.

Simple inventory tracking can be implemented using the standardized short-range EPC (Electronic Product Code) scheme promulgated by EPCglobal, Inc. Readers may be placed proximate ingress and egress points, such as at doorways, and will detect items that are passing through the read zone.

Some inventory systems attempt to determine the location of tagged items. The difficulty is to calculate the object's location based on signals received at a plurality of fixed readers. In some cases, received signal strength measurements may be used. In other cases, time-of-arrival analysis may be used.

In all inventory tracking systems, designers are confronted with the difficulty of producing a transponder capable of performing all the functions necessary to achieve the goals of the system. At the same time the transponders must be lightweight, durable, and cost effective. This limits the processing capacity and battery life of the transponder.

It would be advantageous to provide an RTLS system and transponders for such a system that address, at least in part, one or more of the shortcomings of existing systems.

### SUMMARY OF THE INVENTION

The present application discloses a real-time location system for identifying and locating tagged items. The system may include an identification protocol that tracks in-network transponders and assigns dynamic in-network identification numbers to in-network transponders. Tracking in-network transponders allows the readers and host system to perform more sophisticated scheduling.

The system may include a locator function that employs time-of-arrival analysis. Rather than attempt to synchronize the time base at each reader, the present application describes a system and process that eliminates the need to sync the readers and also eliminates the impact of differential receive delays in the respective readers.

In one aspect, the present application describes a real-time location system. The system includes a plurality of stationary readers and at least one transponder. The transponder includes an antenna, a transceiver, a controller, a power source and memory, the memory containing a unique transponder identification number. The transponder includes a broadcast module configured to broadcast an RF transponder signal containing the transponder identification number when the transponder is in an out-of-network state, and it includes a program module configured to receive RF commands from one of the readers. The program module is configured to transition the transponder to an in-network state on reception of a command signal assigning a node identification number to the transponder. The broadcast module is configured to broadcast the RF transponder signal containing the node identification number instead of the transponder identification number when the transponder is in the in-network state. The node identification number is shorter in length than the transponder identification number.

In another aspect, the present application provides a method of determining location of a transponder in a locating system, the system including a plurality of spaced-apart stationary readers having known locations, one of the readers being designated as a master reader with respect to the transponder and at least three of the readers being designated as slave readers with respect to the transponder. The method includes broadcasting a transponder locate signal from the transponder; broadcasting a master locate signal from the master reader; detecting the master locate signal and the transponder locate signal at each of the slave readers and measuring a delay time between time of receipt of the two signals; calculating a first differential distance between a first one of the slave readers and a second one of the slave readers and the transponder based on the measured delay times at the first and second slave readers, wherein the first differential distance defines a first hyperbola; calculating a second differential distance between a first one of the slave readers and a third one of the slave readers and the transponder based on the measured delay times at the first and third slave readers, wherein the second differential distance defines a second hyperbola; and determining a likely location of the transponder based on a point of intersection between the first and second hyperbolas.

A real-time location system, including at least one transponder, the transponder including an antenna, a transceiver, a controller, a power source and memory and a plurality of spaced-apart stationary readers having known locations. One of the readers is designated as a master reader with respect to the transponder and at least three of the readers are designated as slave readers with respect to the transponder. The system includes a locator processor and locator memory in communication with the plurality of spaced-apart stationary readers, the memory storing a locator module configuring the processor to determine a likely location of the transponder. The transponder is configured to broadcast a transponder locate signal. The master reader is configured to broadcast a master locate signal. Each of the slave readers is configured to receive the master locate signal and the transponder locate signal and measure a delay time between time of receipt of the two signals, and to report the delay time to the locator module. The locator module is configured to calculate a first differential distance between a first one of the slave readers and a second one of the slave readers and the transponder based on the measured delay times at the first and second slave readers, wherein the first differential distance defines a first hyperbola, calculate a second differential distance between the first one of the slave readers and a third one of the slave readers and the transponder based on the measured delay times at the first and third slave readers, wherein the second differential distance defines a second hyperbola, and determine the likely location of the transponder based on a point of intersection between the first and second hyperbolas.

In yet a further aspect, the present application provides a method for compensating for an oscillator error in a transponder, the transponder being adapted for use in a real-time location system including at least one reader. The method including providing transponder with predetermined time interval between transmissions; receiving a first transmission from the transponder; receiving a second transmission from the transponder after a time measured by the at least one reader; determining a difference between the measured time and the predetermined time interval; determining the oscillator error based on the difference and calculating a deviation factor for correcting the oscillator error; and applying the deviation factor at the transponder to correct the oscillator error.

Other aspects and features of the present application will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present application, and in which:

FIG. 1 shows an example embodiment of a real-time location system;

FIG. 2 shows in flowchart form a method of identifying transponders;

FIG. 3 diagrammatically illustrates an embodiment of a beacon signal;

FIG. 4 shows, in block diagram form, an example embodiment of a transponder;

FIG. 5A shows the spectrum of channels divided into a first set of adjacent channels and a second set of adjacent channels;

FIG. 5B shows an embodiment of channel allocation based on interleaving;

FIG. 6A shows, in block diagram form, a portion of the analog transmitter of the transponder;

FIG. 6B shows a portion of the analog receiver of the transponder;

FIG. 7 shows, in flowchart form, an RSSI-based method for locating a transponder;

FIG. 8 diagrammatically shows an RTLS system for performing a time-of-arrival (TOA) location operation;

FIG. 9 shows the system of FIG. 8 with the calculated hyperbolas from the TOA location operation illustrated graphically; and

FIG. 10 shows, in flowchart form, a method of correcting for oscillator drift in a transponder.

Similar reference numerals are used in different figures to denote similar components.

### DESCRIPTION OF SPECIFIC EMBODIMENTS

The present application describes and discloses embodiments of a real-time location system. The system features both identification functions and location functions. That is, in one aspect the system is capable of obtaining identification information from a transponder in the coverage area of the system. As will be described below, transponders may be classified as in-network or out-of-network. Once a transponder has been identified by the system it may be assigned an in-network node identifier and is classed as being in-network. The transponder remains in-network unless it leaves the coverage area or fails to receive communications from the reader for other reasons.

In another aspect, the system is capable of determining the location of an in-network transponder and, thus, the location of the item to which it is attached or with which it is associated. The system 10 may employ received signal strength intensity (RSSI) measurements, time-of-arrival (TOA) mechanisms, combinations thereof, or other mechanisms for determining the location of individual transponders, as will be described below.

Various complications with performing time-of-arrival analysis are addressed in embodiments described below, including the difficulty of synchronizing individual readers receiving signals from a subject transponder.

Embodiments described below also address difficulties with oscillator drift in transponders and the consequent effect on transmission timing and/or frequency accuracy.

The system may also, in some embodiments, exploit other RF-based protocols, including the EPC (Electronic Product Code) scheme promulgated by EPCglobal, Inc. or others, in order to facilitate functions such as locating or programming of the transponders.

System Overview

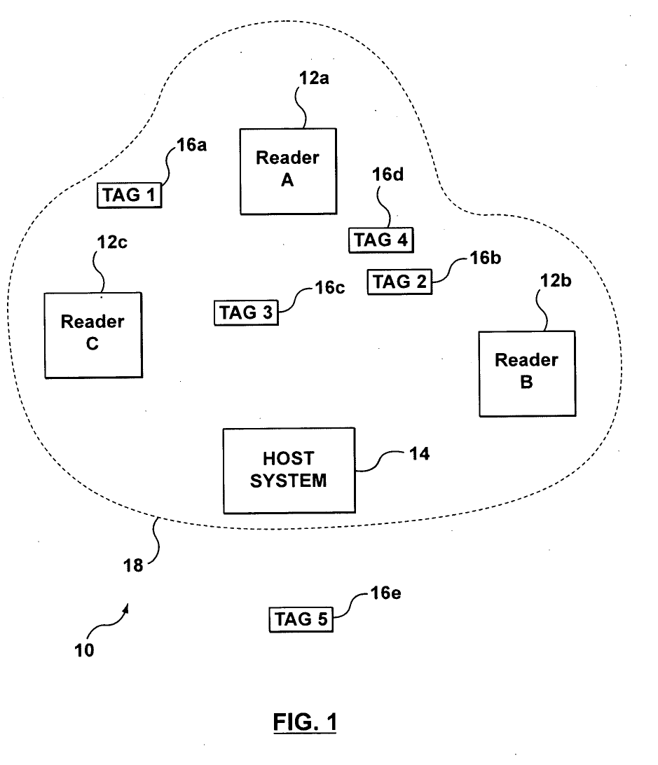

Reference is first made to FIG. 1, which shows an example embodiment of a real-time location system 10. The system 10 includes a number of stationary readers 12 (shown individually as 12a, 12b, 12c), a host system 14, and a plurality of transponders 16 (shown individually as 16a, . . . 16e). The readers 12 are placed in an area that requires monitoring. For example, the readers 12 may be disposed within a warehouse, shipping yard, manufacturing facility, container facility, or any other relatively large location or area in which identification and/or tracking of items may be desirable.

The readers 12 and transponders 16 are configured to communicate using radio frequency (RF) transmissions. The readers 12 each include a transceiver, an antenna, and processing components for receiving RF transmissions from transponders within a coverage area. The coverage area defined for each reader 12 is dependent upon the antenna characteristics, the RF frequencies used, the power levels of the RF transmissions, and the physical characteristics of the environment. The coverage areas may be non-uniform due to multipath, attenuation, and other effects of the physical environment on RF propagation.

The antennas selected for the readers 12, the RF frequencies used, and other characteristics of the system 10 may be chosen to provide the system 10 with “medium range” communication capability, where medium range is up to, for example, half a mile. In one embodiment, the readers 12 and transponders 16 are configured to use the ISM (Industrial, Scientific and Medical) band at 902-928 MHz. In other embodiments, the system 10 may employ one of the ISM bands at, for example, 433 MHz 2.45 GHz and/or 5.8 GHz. Other frequencies may also be used, subject to local restrictions regarding output power and spectrum allocation.

In some instances, the frequency band, such as 902-928 MHz may be divided into multiple frequency channels. Further details regarding frequency channel allocation and frequency hopping in one embodiment are outlined below.

The readers 12 are placed so as to provide substantial overlap in coverage areas. The overlapping coverage areas define a coverage zone 18 for the system 10 within which transponders 16 may be detected by the readers 12 and outside of which transponders 16 cannot be detected by the readers 12. In general, readers 12 may be placed so as to define the coverage zone 18 to be sufficiently large to enable identification and location of a transponder 16 within the facility or area intended to be monitored by the system 10, but not so large as to cause interference with neighbouring systems.

In one example embodiment, each of the readers 12 is disposed on a lamppost or other tall structure. In such an embodiment, the readers 12 may be equipped with directional antennas that tend to focus the coverage area of the readers 12 downwards into the monitored area.

The transponders 16 (sometimes called tags) may be affixed to movable items for the purpose of identifying and/or locating the items in an inventory tracking system. In some cases, the transponders 16 may be affixed to containers, pallets, or other movable storage devices in or on which multiple items may be stored.

The transponders 16 are active devices, having a power source, such as a battery, and having a transceiver capable of generating an RF signal for transmission to the readers 12. Each transponder 16 includes a memory storing transponder information including a unique transponder identification (ID) number. In general, the transponders 16 each broadcast their respective transponder information at regular intervals. In other words, each transponder 16 periodically transmits an RF signal containing its transponder ID number. This RF transmission may be referred to as a beacon signal. If a transponder 16 has not registered with the system 10, then the transponder 16 may be configured to broadcast its beacon signal containing its transponder ID number after a predefined interval. For collision avoidance, the predefined interval for any given transponder may be a fixed portion plus or minus a pseudorandom adjustment amount.

If a transponder 16 has registered with the system 10, e.g. is classified as “in-network”, then the transponder 16 may be configured to broadcast a beacon signal containing its transponder ID number after an interval duration fixed by the reader 12. The reader 12 may avoid collisions between known transponders 16 by scheduling the beacon signals of known transponders 16 in its vicinity so as to occur at non-interfering times. The transponders 16 may be configured to set their interval duration and/or frequency channel based on a command from the reader 12. It will be appreciated that in some jurisdictions local regulations will prevent the reader 12 from selecting a frequency channel for a transponder 16 for the purpose of collision avoidance, for example in the United States under FCC regulations. The frequency channels used by the transponders 16 follow a pseudo-random sequence.

In one aspect, the system 10 may assign a node ID to any transponder 16 detected within the coverage zone 18. The node ID may be significantly shorter than the transponder ID number. When transmitting its beacon signal, the transponder 16 may send its assigned node ID instead of its transponder ID number. Accordingly, the beacon signal sent when “in-network” may be significantly shorter than when “out-of-network”. This feature may assist in reducing power consumption for transponders 16 once they are “in-network” by reducing the length of their regular beacon transmissions.

In one embodiment, the node ID has a variable length, which adjusts to the size of the population dynamically. In other words as the system 10 determines that the population of transponders 16 present is sufficiently large to justify adding another digit to the node ID, it may communicate this to the transponders 16. Existing node IDs assigned to in-network transponders may be adjusted by the transponder 16 to add a leading zero. Alternatively, the format of the node IDs may be such that is it apparent to a reader whether it is a longer or shorter node ID. In another embodiment, the readers 12 may reassign node IDs to the in-network transponders 16.

If a transponder 16 has not been updated with in-network commands from the system 10 for a predefined time, the transponder 16 may be configured to transition back to “out-of-network” status and resume broadcasting its transponder ID number. For this purpose, the transponder 16 may contain a clock function for monitoring the time from the most recent reader communication 12 to the transponder 16 and determining whether the monitored time exceeds the predefined time. The system 10 may also maintain a clock function for tracking the time between receipt of transponder 16 beacon signals. If the system 10 fails to receive a beacon signal from an in-network transponder 16 within a preset duration, it may presume the transponder 16 has left the network and may release its node ID. In general, the preset duration tracked by the system 10 for releasing node IDs is longer than the predefined time after which a transponder 16 transitions to out-of-network status. Alternatively, instead of tracking time elapsed, the system 10 may track “communication opportunities”.

Following transmission of a beacon signal, the transponder 16 listens on the same frequency channel for a response signal from one of the readers 12. As will be described below, the system 10 ensures that one of the readers 12 is identified as a “master” reader with regard to each transponder 16. The identification of a “master” reader may be based on the relative RSSI values at each reader 12 that receives a beacon signal. The reader 12 receiving the strongest transmission from the transponder 16 may be designated the “master” reader with respect to that transponder 16, whereas the other readers 12 are designated “slave” readers insofar as the locator operation is concerned. The locator operation will be described in detail in a later section of this description. Also described later are the various mechanisms for facilitating reader-to-reader and/or reader-to-host communications.

In many embodiments, the reader-to-host communications and the designation of a “master” reader will not be fast enough to enable a reader to place a transponder 16 “in-network” using a response signal sent after its first detected broadcast transmission. In other words, the system 10 needs to wait until the next broadcast to send a response signal assigning the transponder 16 a node ID and placing it “in-network”. If the predefined interval duration is significant, such as 30 minutes, then the fastest that a transponder 16 can be placed in-network is 30 minutes. Depending on when in its broadcast cycle the transponder 16 first comes into the coverage area 18 of the system 10 it may therefore take anywhere from 30 to 60 minutes to place the transponder 16 in-network.

In one embodiment, the out-of-network predefined interval between broadcasts may include a long interval followed by a short interval. For example, the predefined interval may include a first interval of 30 minutes followed by a second interval of 1 minute. The second interval is selected to be sufficiently long to permit a reader 12 to complete the reader-to-host communications and determine the “master” reader. In this example, the time it takes to place a transponder 16 in-network is usually 1 minute. If the second transmission is the first one detected, then it takes 30 minutes. Accordingly, depending on when in its broadcast cycle the transponder 16 first comes into the coverage area 18 of the system 10, it may take between 1 and 31 minutes to place the transponder 16 in-network. This “stutter-step” broadcast timing protocol thus ensures that transponders are more quickly placed in-network.

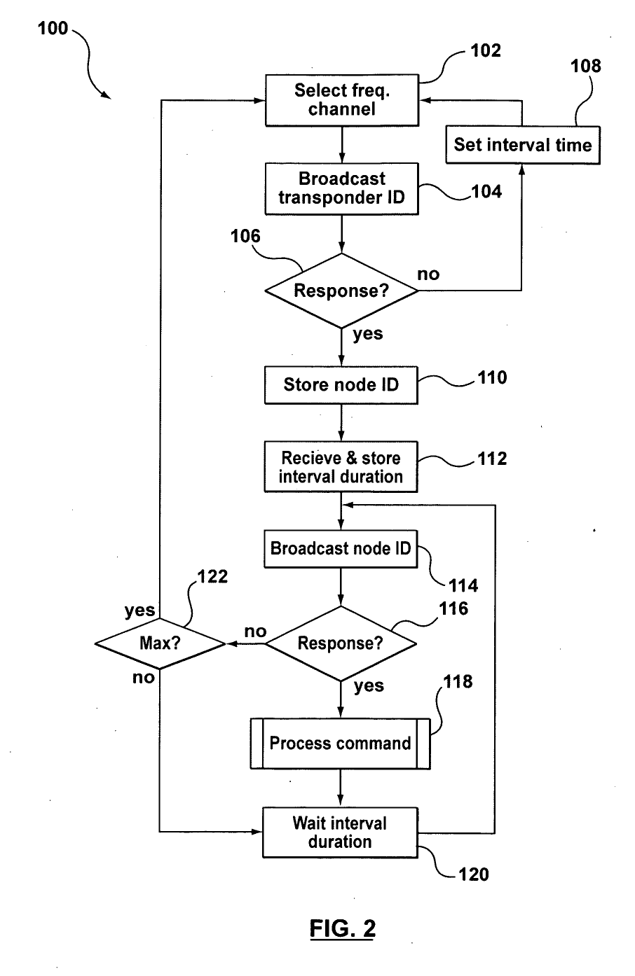

Reference is now made to FIG. 2, which shows in flowchart form a method 100 of identifying transponders. The method 100 begins in step 102 with the “out-of-network” transponder 16 selecting a frequency channel. As will be further described below, the transponders 16 may implement a channel/frequency hopping scheme for selecting a channel in a pseudorandom manner. The channel selection may, in some embodiments, be in accordance with a predetermined schedule stored in memory on the transponder 16. The local oscillator is tuned to the selected frequency channel to generate the desired carrier frequency for the channel.

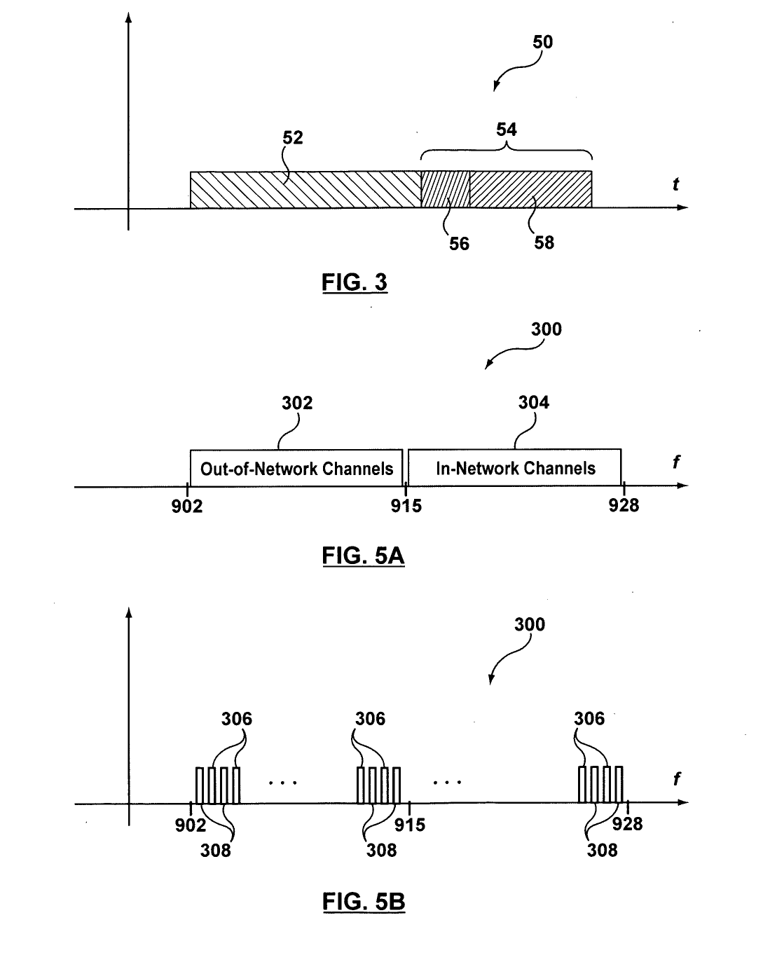

In step 104, the transponder 16 broadcasts its beacon signal in the selected frequency channel. Reference is now also made to FIG. 3, which diagrammatically illustrates an embodiment of a beacon signal 50. The beacon signal 50 includes a transmission indicator signal 52 followed by a message 54. The transmission indicator signal 52 is a characteristic signal identifiable by the readers 12 as indicative of an upcoming transponder message. The transmission indicator signal 52 may, in some embodiments, be a single tone. In other embodiments, the transmission indicator signal 52 may include a predefined data pattern or other characteristics. It has a duration sufficient to permit one of the readers 12 to detect the transponder transmission, taking into account the channel scanning speed of the readers 12. The precise length of the transmission indicator signal 52 may depend in part on the number of readers 12, the number of channels, the channel scanning algorithm used by the readers 12, the speed of the receiving architecture of the readers in detecting the presence of a transmission in a channel, and other factors. In one embodiment, the transmission indicator signal 52 has a duration of about 5 milliseconds.

The message 54 includes a preamble 56 and transponder information 58. The preamble 56 may include a preset code or pattern that permits the reader(s) 12 to lock-in and synchronize to the message 54. The transponder information 58 includes at least the transponder ID number. The transponder ID number is a unique multi-digit number assigned at the time of manufacture. It may be stored in a read-only portion of the transponder memory. In one embodiment, the transponder ID number is 48 bits. The transponder information 58 may also include other data stored in the transponder memory. By way of example, the transponder information 58 may include information regarding the item or container associated with the transponder, transponder history (i.e. last update), and other such information.

Referring still to FIG. 2, following the transmission of the beacon signal 50, the transponder 16 switches to a receive mode and listens for a response signal from one of the readers. In one embodiment, the transponder 16 is configured to listen on the same channel as it had broadcast its beacon signal 50. The transponder 16 is configured to listen for a predetermined length of time before determining that there is no response. Detected RF transmissions in the channel are demodulated and the transponder 16 determines whether the detected transmission is a proper response signal. A proper response signal may be identified by a predefined preamble or other indicator that signifies a response signal from one of the readers 12. In addition to determining that the response signal has been received from one of the readers 12, the transponder 16 determines whether the response signal is addressed to the transponder 16 or is intended for another transponder. A response signal addressed to the transponder 16 contains the transponder ID number.

If, in step 106, a response signal to the transponder 16 is detected, then the method 100 continues at step 110. Otherwise, if the predetermined time expires without detection of a proper response signal, then the method 100 loops to step 108, wherein an interval time is set. As noted above, the interval time may include a preset duration plus or minus a pseudorandom adjustment. The pseudorandom adjustment ensures that two transponder 16 that collided by transmitting beacon signals at the same time in the same channel do not continue to collide by transmitting again after the same interval time. Although the transponders 16 frequency hop, they may use an identical pseudorandom frequency hopping schedule for determining the next channel and, thus, may continue to collide indefinitely. By making pseudorandom adjustments to the interval time, the likelihood of subsequent collisions is vastly reduced.

Before proceeding to steps 102 and 104, the transponder 16 waits for the interval time to elapse. Power saving processes may be employed in this interval time. Minimal circuitry may be kept powered for determining the appropriate time at which to ‘wake-up’ the remainder of circuitry for the purpose of generating the beacon signal at the appropriate time.

In step 110, the transponder 16 stores the node ID assigned by the reader 12 in the response signal. In some embodiments, the reader 12 may not assign a node ID in the initial response signal; it may be assigned during a subsequent command sequence. However, for the present embodiment, it is assumed that the response signal contains assignment of a node ID to the transponder 16. In one alternative embodiment, the reader 12 may keep the transponder 16 in out-of-network status after its initial contact, but may shorten the interval to the next transmission. This allows for the fact that a transponder's first appearance in the system 10 likely indicates a transponder on the move and the delay in placing it in-network allows it to reach a stationary position before it is brought “in-network” or for it to pass through the system 10 altogether.

It is also presumed for this example embodiment that the response signal includes assignment of an interval duration. The assigned interval duration is stored by the transponder 16 in step 112. Once the transponder 16 is “in-network” the host 14 and/or reader 12 may adjust (typically lengthen) the interval duration used by the transponder 16. In some embodiments, the host 14 or reader 12 may select an interval duration for the transponder 16 having regard to the expected transmission times of other in-network transponders 16. In this manner, the likelihood of collision can be minimized by preventing collisions between in-network transponders 16 through appropriate transmission scheduling. The interval duration may be adjusted or changed by the system 10 using later commands as scheduling demands.

Subject to local regulations, the response signal from the reader 12 may also specify the channel within which the transponder 16 is to broadcast its next beacon signal. In another embodiment, the response signal may provide a seed or code from which the transponder 16 can derive a channel hopping schedule using a pre-defined algorithm or lookup table. As will be described below, the frequency channels used for in-network transponders 16 may differ from those used for out-of-network transponders 16.

In accordance with the assigned interval duration, the transponder 16 awaits its ‘timeslot’ and then broadcasts a beacon signal (step 114). The beacon signal transmitted by an in-network transponder 16 is not the same as the out-of-network beacon signal 50 shown in FIG. 3. In particular, it may use a substantially shorter transmission indicator signal and the message portion of the in-network beacon signal contains the node ID instead of the transponder ID number. In some embodiments, the in-network beacon signal does not include a transmission indicator signal, since the reader 12 is aware of when and in what channel the transponder 16 is to transmit. In some embodiments, the in-network transmissions may be at a different (possibly higher) data rate and/or power level.

After broadcasting its in-network beacon signal in step 114, the transponder 16 awaits a response signal from one of the readers 12 (step 116). If a response signal is received it may contain one or more commands. Example commands are outlined below in greater detail; however, they may include assignment of a new node ID, specification of an interval duration or frequency channel for the next beacon signal, or other instructions. Any commands or other programming instructions received in the response signal are processed by the transponder 16 in step 118. The transponder 16 then waits the interval duration 120 in step 120 before returning to step 114 to re-broadcast its in-network beacon signal. It will be appreciated that the transponder 16 may enter a low-power sleep mode between broadcasts to preserve power.

If a response signal is not received by the transponder 16 in step 116, then in step 122 the transponder 16 assesses whether it has reached an maximum number of broadcasts without a response or a maximum time without detecting a response signal. If not, then the transponder 16 awaits the interval duration in step 120. However, if the transponder 16 determines in step 122 that it has not received a response signal after a maximum amount of time or number of beacon signals, then it may conclude that it is out of the coverage zone 18 for the system 10 or has otherwise lost its in-network status with the system 10 due to interference or other communication problems. As a result, the transponder 16 resets its status to out-of-network by returning to step 102 and clearing its memory of any assigned node ID and assigned frequency channels or interval durations.

Transponder Overview

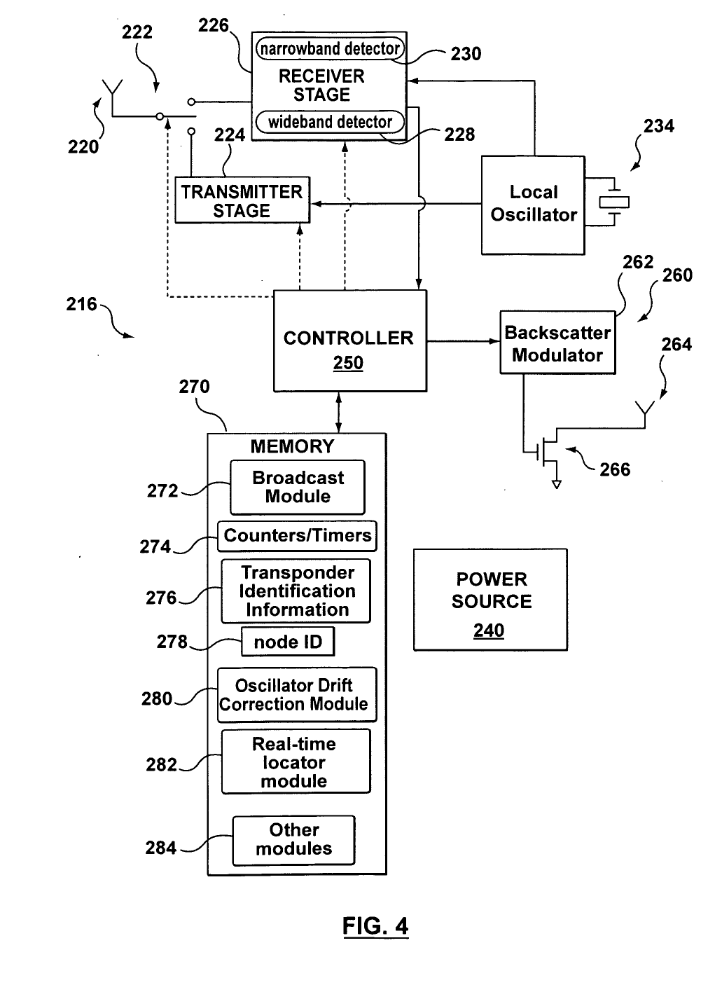

Reference is now made to FIG. 4, which shows, in block diagram form, an example embodiment of a transponder 216. The transponder 16 includes an RF antenna 220, a controller 250, a transmitter stage 224, a receiver stage 226, and a power source 240. The antenna 220 is connected to the receiver stage 226 and transmitter stage 224 through a transmit/receive (T/R) switch 222. The T/R switch 222 operates in response to a switch signal from the controller 250. The controller 250 also controls operation of the transmitter stage 224 and receiver stage 226.

The transmitter stage 224 and receiver stage 226 both receive oscillator signals from a local oscillator 232 that generates the oscillator signals based on a crystal 234. The frequency of the oscillator signals are tunable based on oscillator control signals from the controller 250 to the local oscillator 232. In one embodiment, the local oscillator 232 is implemented as a fractional-N synthesizer in order to permit tuning of the oscillator signal in relatively fine steps. The fractional-N synthesizer tunes the frequency of the oscillator signal on the basis of a codeword supplied by the controller 250.

The power source 240 may, in many embodiments, include a battery or other such energy storage element. In some embodiments, additional power source elements may be present. For example, the transponder 16 may include capacitive or inductive based vibratory energy converters for generating energy from kinetic energy. Such a converter may be used to supply a trickle charge for recharging a battery when the transponder 16 is in motion. In other embodiment, the transponder 16 may include solar or other energy converters for harvesting energy and charging a battery. It may also or alternatively be equipped with a recharging port to permit connection to a recharger.

The receiver stage includes a narrowband or channel detector 230 and a wideband detector 228. The channel detector 230 is for receiving RF signals on a selected channel. In this regard, the signal from the local oscillator 232 is tuned to the frequency of the selected channel, or some multiple or fraction thereof, and the channel detector 230 includes a down-converter. The channel detector 230 may further include filtering, an A/D converter, and other common receiver elements.

The wideband detector 228 is a shorter range (lower sensitivity) detector for detection of signals across a wider frequency range but shorter distance than the channel detector 230. For certain applications, the transponder 216 may be configured to monitor all channels for a trigger signal, wakeup signal, or other RF communication. For example, portable handheld readers for location detection may be detected using the wideband detector 228.

In some embodiments, the wideband detector 228 is implemented using one or more passive components to minimize current consumption. For example, the wideband detector 228 may be implemented using a diode rectifier structure. Circuitry for evaluating whether the received signals are a legitimate wakeup signal or other signal to which the transponder 216 needs to respond may be wholly or partly powered by the rectified RF energy from the received signal. The format for legitimate signals that the transponder 216 need to detect may be selected so as to be recognizable by the transponder 216 using such a structure. Thus the wideband detector 228 may consume little or no battery power.

The transponder 216 may, in some embodiments, also include a backscatter modulator 260. For example, the backscatter modulator 260 may include an antenna 264, a transistor 266 and a backscatter modulation stage 262. The backscatter modulator 260 is configured to receive a continuous wave RF signal and to modulate the RF signal through controlling the loading of the antenna 264. By controlling the reflective/absorptive characteristics of the antenna 264 and transistor 266 combination, the backscatter modulation stage 262 can communicate data back to the device providing the continuous wave RF signal, in known manner. The backscatter modulator 260 may, in some embodiments, be used by portable handheld devices for location detection, for identification purposes, or for other applications.

The transponder 216 further includes a memory 270. The memory 270 may, in some embodiments, be partly or wholly integrated as part of the controller 250. In some instances, the memory 270 may include read-only memory and random access memory. A portion of the memory 270 may be flash memory.

The memory 270 may store program instructions or modules for configuring the controller 250 to execute certain functions or operations. The programming of the controller 250 and memory 270 to execute the functions or operations described herein may be implemented in any number of languages suitable for use with the particular controller 250 and other components and the programming of such will be within the skill of a person of ordinary skill in the art having regard to this description. In another embodiment the controller 250 and program instructions or modules may be implemented as an application specific integrated circuit (ASIC).

In some embodiments, the memory 270 may include a broadcast module 272 or component for causing the transponder 216 to broadcast its beacon or identifying signal. In this regard, the memory 270 may also store transponder identification information 276 and, if placed in-network, a node ID 278 for inclusion in the beacon signal. The broadcast module 272 may include or may interface with counters/timers 279 for determining when to transmit the beacon signal.

In some embodiments, the memory 270 may include an oscillator drift correction module 280 for compensating for inaccuracies in the oscillator signal, which may impact the generation of carrier frequencies and/or the timing of broadcast intervals, as will be described in greater detail below.

In some embodiments, the memory 270 may include a real-time locator module 282 for generating and sending locator signals to enable the system to pinpoint the location of the transponder. The use of locator signals is described in greater detail below.

The memory 270 may further include other modules or components executable by the controller 250 to enable the transponder 216 to perform the functions or operation described herein, including any functions or operations required by commands received by the transponder 216 from a reader.

System Communication Protocol

A. Frequency Channels

As noted above, the system 10 may use any suitable range of frequencies. In many embodiments it may use one of the ISM bands. For the purpose of illustration, the example embodiment described below uses the 902-928 MHz ISM band; however, it will be understood that the present system 10 is not limited to this band.

As with most bands, the 902-928 MHz band is subject to various regulatory constraints. For example, the governing regulatory authority in a given jurisdiction may proscribe transmission power limits. When the band is divided into channels, it may be necessary to use frequency hopping to transmit sufficient power in the channel yet stay within the regulator constraints or to use spread spectrum transmission. In many embodiments of the present system 10, frequency hopping is employed for the locating function.

Equipment in the 902-928 MHz band typically uses 50 channels with center frequencies at 902.75 MHz+n*0.5 MHz with n being the channel number from 0 to 49. Accordingly, to minimize potential interference with other equipment, an embodiment of the present system may use center frequencies of 903 MHz+n*0.5 MHz with n ranging from 0 to 48. An additional channel is located either at 902.5 MHz or at 927.5 MHz.

In some embodiments, the channels may be allocated into out-of-network channels and in-network channels. In other words, a certain number of channels may be reserved for in-network communications with the remainder being for out-of-network communications. This provides greater certainty to the scheduling of in-network transmissions since there is no risk of out-of-network transponders broadcasting at the same time in the same channel as a scheduled in-network transmission.

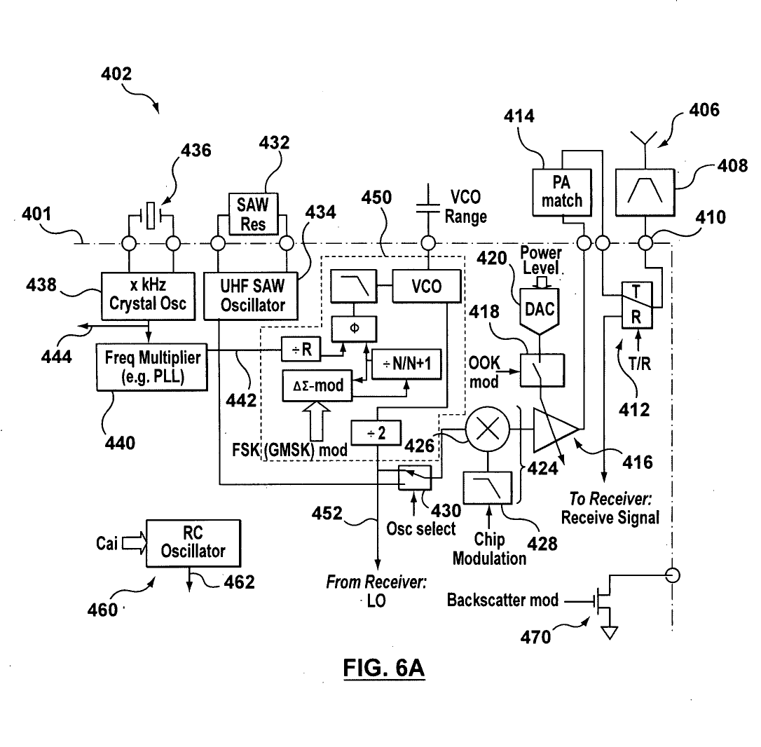

In one embodiment, as illustrated graphically in FIG. 5A, the spectrum of channels 300 may be divided into a first set of adjacent channels 302 and a second set of adjacent channels 304. The first set of adjacent channels 302 is allocated for either in-network or out-of-network communications, and the second set of adjacent channels 304 is reserved for the other type of communications. In the example of FIG. 5A, the first set of adjacent channels 302 is for out-of-network communications and the second set of adjacent channels 304 is for in-network communications. Although FIG. 5A indicates that approximately the same number of channels are in each set 302, 304, it will be appreciated that either set may contain more or fewer channels than the other.

In another embodiment, the in-network and out-of-network channels may be interleaved. Reference is made to FIG. 5B, which graphically illustrates this channel allocation. The spectrum of channels 300 includes alternating out-of-network channels 306 and in-network channels 308. Although FIG. 5B indicates that there are the same number of out-of-network channels 306 and in-network channels 308, it will be appreciated that either set may contain more or fewer channels than the other. In one embodiment, the out-of-network channel set may consist of just one channel, perhaps with a lower transmission power level to comply with local regulations. This embodiment may allow for faster detection of transmissions by the reader. The reader may be made more sensitive by using a narrower bandwidth to compensate for the lower transmission power level.

Regardless of the precise channel allocation scheme, the bandwidth of an in-network channel and an out-of-network channel need not necessarily be identical. For example, a lower data rate and, thus, narrowed bandwidth channel, may be used for either the in-network or out-of-network channels. This may lead to closer spacing of center frequencies in some embodiments.

B. Command Protocol

As noted previously, transponders 16 may be in-network or out-of-network. Out-of-network transponders 16 broadcast their transponder ID information at pseudorandom interval times. In-network transponders 16 are assigned node IDs and they broadcast their node IDs after an assigned interval duration. Both in-network transponders 16 and out-of-network transponders 16 may broadcast on a channel selected using a pseudorandom frequency hopping schedule. Whether in-network or out-of-network, after broadcasting on a given channel, in many embodiments the transponders 16 then listen for a response signal on the same channel within a predetermined response period. Alternatively, the transponders 16 may listen on the next channel indicated by the pseudo-random frequency hopping schedule. The transponder 16 may inform the reader 12 of the channel on which it will be listening for a response.

The response signal from a reader 12 may contain one or more commands to the transponder 16. Example commands may include:

Assign node identification number. The system 10 may assign a node ID that is substantially shorter than the transponder identification number, thereby potentially reducing the transmission length. The transponder 16 stores the node ID and uses it in place of the transponder identification number for in-network broadcasts.

Set interval duration. This command assigned an interval duration to the transponder 16. In some embodiments, it may also be used as the seed or a code from which the transponder 16 derives an interval duration, such as from a stored look-up table or stored schedule.

Set frequency channel. This command may assign a frequency channel for the next broadcast by the transponder 16, subject to local regulations regarding frequency use and pseudorandom hopping requirements. In one embodiment, the reader may assign the frequency channel to be used until further notice. In some embodiments, it may be a seed or first channel after which the transponder 16 selects subsequent channels in accordance with a schedule.

Listen Only. This command may cause the transponder 16 to forbear from transmitting after the interval duration and only listen for a “response” or command signal from one of the readers 12. This permits the system 10 to reduce the number of transmissions from known in-network and mostly stationary transponders 16, but still command and program those transponders 16. In various embodiments, the command may be effective for a single cycle, for a specified number of cycles, or indefinitely until instructed otherwise.

Send data. This command instructs the transponder 16 to transmit its data in the next broadcast. In some embodiments, it may cause the transponder 16 to immediately broadcast its data. In yet other embodiments, the command may include parameters for specifying certain data that the transponder 16 is to transmit.

Transmit RTLS message. As will be explained in greater detail below, the location function of the system 10 may include instructing the transponder 16 to transmit a location message. The location message differs from the regular identification broadcast message. In some embodiments, the location message may include a spread spectrum signal.

Adjust transmit level for ID messages. This command allows the system 10 to adjust, typically lower, the power level for identification messages broadcast by the transponder 16. In the case of identification messages, in-network transponders need only be detectable by a single reader 12, meaning that the output power level may be reduced so that only the closest reader 12 receives a meaningful level signal from the transponder 16. This may assist in reducing power consumption on the transponder 16 and in preventing collisions.

Adjust transmit level for RTLS messages. This command permits separate power control for location messages.

Adjust transmission indicator. The transmission indicator signal 52 (FIG. 3) may be adjustable, allowing the system 10 to shorten or lengthen the duration of the signal in certain circumstances. For example, when in-network a shorter transmission indicator signal 52 may be permissible since the readers 12 generally know when and in which channel the transponder 16 is going to broadcast. In some embodiments, the transponder 16 may be configured to listen in a channel before broadcasting. If the transponder 16 detects an interfering transmission in its timeslot, then it may delay transmission and/or switch to a different channel. In these circumstances, a longer transmission indicator may be required to allow the readers 12 to detect the delayed/moved transmission.

The response signal may include at least a node ID field and a command field. In some embodiments, the response signal may contain multiple command fields and a number of commands parameter that indicates the number of command fields in the response signal. The node ID field and the command field may have variable lengths.

The transponders 16 may have states other than “in-network” and “out-of-network”. For example, a transponder 16 may be configured to be placed in a “quiet” state, either indefinitely or for a configurable length of time. In this state, the transponder 16 may listen at certain intervals to determine if it can detect whether transponder/reader communications are present but will not broadcast. The “quiet” state may be useful if the transponder 16 is in transit, especially in environments in which the transponder 16 is not permitted to broadcast, such as in an aircraft. Transition to or from a “quiet” state may be triggered by a general wakeup signal, perhaps from a handheld unit, and detectable by the transponder 16 using its wideband receiver.

Additionally or alternatively, the transponder 16 may have a “sleep” state in which it neither broadcasts nor listens. The “sleep” state may have a predefined duration.

C. In-Band Reader-Host Communications

In one embodiment, the readers 12 and host 14 communicate over a communications medium separate from the RTLS system 10. For example, each reader 12 may be configured with a WiFi transceiver adapted for IEEE 802.11 communications. In yet another example, the readers 12 and host 14 are networked together over a wired LAN. Other examples will be apparent to those skilled in the art.

However, in one embodiment, the reader-to-reader and reader-to-host communications are carried out in-band within the same frequency band used for transponder identification/location functions. Using in-band frequencies reduces the number of distinct components required for the receivers, thereby reducing their cost, and reduces the latency associated with some networks, such as 802.11. In addition, for the system 10 to otherwise operate favourably, the environment is likely to be favourable for the identification/location frequency band, whereas it may prove unfavourable for other frequency bands, like 802.11. Use of in-band communications also avoids the cost associated with providing a wired network between readers 12 or between the readers 12 and the host 14. Additionally, use of in-band communications for reader-to-host and reader-to-reader communications allows for diagnostic purposes, i.e. transmit and receive function diagnostics. Alternatively, a combination may be used where some links are implemented by a high speed link and others are implemented using in-band because of unavailability of the high-speed link

In this in-band embodiment, the readers 12 are each assigned a node ID, as is the host 14. Communications from one reader 12 to another or to the host 14 are addressed using the respective node ID. In some embodiments, the reader-to-host and host-to-reader transmission may be at a higher power level than the reader-to-transponder communications since the distances between readers 12 and the host 14 may be many times larger than the ordinary coverage zone of a reader 12. In another embodiment, reader-to-host communications may be cascaded through adjacent readers 12 to reach the host 14 and back again.

In some embodiments, the system 10 may reserve one or more channels for reader-to-reader and/or reader-to-host communications. In other embodiments, reader-to-reader and reader-to-host communications use the same channels as the in-network and/or out-of-network communications.

D. Reader Channel Scanning

Each reader 12 has at least one receiver configured to scan the frequency channels for the presence of a transmission indicator signal. The receiver listens on a channel for a period of time sufficiently long to determine whether a transmission indicator signal is present. If no transmission indicator signal is present, then the receiver steps to another channel with a fast frequency hop. The transmission indicator signal has a duration sufficiently long to enable a receiver to scan a substantial number of channels. If all channels cannot be scanned within the duration of the transmission indicator signal then the reader 12 may include more than one scanning receiver to enable scanning of separate sets of channels at the same time and ensure complete coverage of all channels.

In an alternative embodiment, the reader 12 may contain a receiver configured to sample a significant part o the band or the entire band, i.e. all channels, using a wideband receiver stage. The receiver then performs a Fast Fourier Transform (FFT) on the sampled data. From the results of the FFT, the receiver can identify channels containing a transmission indicator signal.

In yet another embodiment, the receiver sub-samples the band with a sampling frequency twice the channel width. This folds all the channels into one channel due to aliasing. With proper alignment, the transmission indicator signals are distinguishable per channel. Proper alignment means that base-band frequencies of the transmission indicator signals differ from channel to channel and that the frequency layout of even channels is mirrored from odd channels. This embodiment permits the use of lower speed A/D converters and a lower speed FFT calculation, which in turn reduces the cost of the receiver.

In any of the embodiments, the transmission indicator signal may be a single tone signal. In some embodiments, the transmission indicator signal may be an alternating two-tone signal. In yet other embodiments, the transmission indicator signal may be a predefined sequence of tones.

In some embodiments, the transmission indicator signal may have data encoded therein. For example, the channel number may be encoded in the signal. This may be valuable in cases whether oscillator drift make the frequency selection less accurate and it becomes difficult to determine whether a transmission is intended for one channel or its neighbour. Alternatively, or in addition, the results of the FFT can be used to tune the receiver bandwidth exactly to the transmit signal to optimize receiver sensitivity.

Once a receiver in a reader 12 detects a transmission indicator signal, it may stay locked on the channel to receive the subsequent data communication. Thus, it is unavailable for channel scanning for a period of time. Therefore, it may be advantageous to have additional receivers that can jump into the scanning pattern when a given receiver is removed to perform data reception. Alternatively, there may be separate receivers for scanning and for data reception, meaning that when a transmission indicator signal is detected the scanning receiver continues to scan and one of the data reception receivers tunes to the identified channel to receive the subsequent data message. This may permit optimization of the receivers to their specific function.

E. Reader Collision Avoidance

Typically, an out-of-network transponder 16 broadcast transmission may reach more than one reader 12. In some instances, the broadcast signal may be detected by three, four, or more readers 12. After a broadcast, the transponder 16 awaits a response signal from a reader 12. Multiple readers 12 may attempt to communicate with the transponder 16 at the same time, causing collisions.

In a first embodiment, the multiple readers 12 each transmit a response signal, but after a pseudorandom delay. The pseudorandom delay may be partly based on the received RSSI value of the transponder 16 broadcast. A reader 12 scheduled to send a response signal may first listen in the channel to determine whether another reader 12 is transmitting before sending its response signal. If an interfering transmission is detected, the reader 12 delays. The transponder 16 receives each of the response signals, measures the RSSI values of each response signal, compiles a list of the RSSI values, and then transmits the list in a further broadcast signal. Each reader 12 then receives the RSSI list from the transponder 16 and can determine whether it should perform the function of “master” reader for subsequent in-network communications with the transponder 16 based on which reader 12 has the highest RSSI value. Moreover, based on the relative rankings on the list of RSSI values, the readers 12 may determine whether they should participate as “slave” readers for location purposes, as described below in the section on location determination.

In this first embodiment, colliding response signals are possible, but the identification of a “master” reader is completed relatively quickly without the delay that may be involved in reader-host communications.

In a second embodiment, the host 14 is involved and response signal collisions are avoided entirely. In this second embodiment, none of the readers 12 respond to the initial transponder 16 broadcast signal. The interval between two transponder 16 transmissions is sufficiently long to enable the readers 12 to communicate with the host 14 and to identify the “master” reader. All readers 12 that detected the initial transponder 16 broadcast signal report the RSSI value of the signal to the host 14. The host 14 then determines, based on the RSSI values, which reader 12 should act as the “master” reader for subsequent communications with the transponder 12. The host 14 communicates “master” and “slave” assignment information back to the readers 12. The host 14 communication may include the node ID, channel and/or interval duration that are to be assigned to the transponder 16 in the command signal. When the transponder 16 next broadcasts its out-of-network signal, the master reader 12 sends a response signal with the assigned node ID, channel and interval duration information.

Transponder Architecture

In one embodiment, to reduce the cost of the transponder much of its functionality may be implemented by way of an application specific integrated circuit (ASIC). The ASIC is configured to ensure that it provides the requisite functionality for implementing the identification and location functions of the RTLS system 10 described herein. The ASIC may further be configured to ensure that it is adaptable to other applications, such as, for example, electronic toll collection (ETC) using an ETC communications protocol. In yet other embodiments, the ASIC may be configured to detect and respond in accordance with other protocols, such as the EPC (Electronic Product Code) scheme promulgated by EPCglobal, Inc. Multi-protocol operation of the transponder is described in additional detail in later sections.

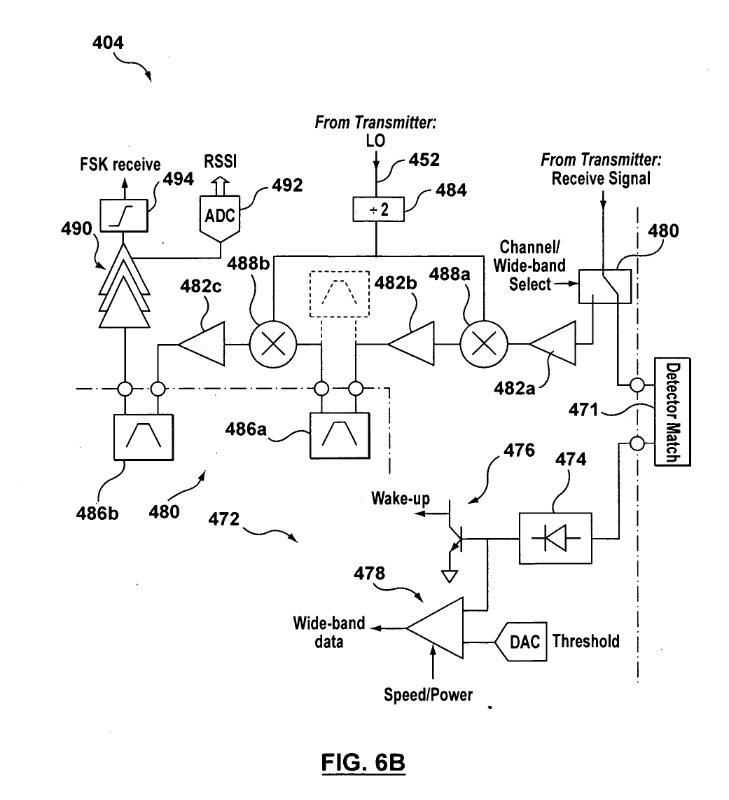

Reference is now made to FIGS. 6A and 6B, which schematically show an example embodiment of a transponder for use in an RTLS system 10. FIG. 6A shows, in block diagram form, a portion of the analog transmitter 402 of the transponder, whereas FIG. 6B shows a portion of the analog receiver 404 of the transponder.

Referring first to FIG. 6A, in this embodiment much of the analog circuitry for the transmitter 402 is contained within the ASIC. The dashed line 401 represents the division between discrete components and the components within the ASIC. Starting with discrete components, the transponder includes an antenna 406 which may, in some cases, be connected to a bandpass filter 408 before it is connected to the antenna pin 410 on the ASIC.

The antenna pin 410 leads to a transmit/receive switch 412. The transmit/receive switch 412 selectively connects the antenna 406 to either the transmitter portion 402 of the ASIC or to the receiver portion 404 of the ASIC. In the illustration of FIG. 6A, it is shown connected to the transmitter portion 402. The transmit/receive switch 412 is controlled by a transmit/receive input signal from a processor (not shown). It will be appreciated that the processor/controller and other elements of the digital portion of the transponder are also integrated into the ASIC, but are not illustrated in FIGS. 6A and 6B for simplicity. The processor/controller may execute one or more software programs to implement the functionality described herein. The suitable programming of the processor/controller will be understood by those ordinarily skilled in the art. It will also be understood that the processor/controller may partly or wholly be implemented using an ASIC.

The transmitter portion 402 generally includes a power amplifier stage, a synthesizer 450, and one or more oscillators. The power amplifier stage includes a power amplifier 416. The power amplifier 416 may have a variable gain and may be connected to an on-off keyed (OOK) modulation switch 418. The OOK switch 418 is not used in the RTLS system but may be useful in other applications. A power level signal and a digital to analog converter (DAC) 420 may provide the adjustable gain signal to the power amplifier 416. The amplified signal output from the power amplifier 416 may be fed to the transmit/receive switch 412 through an impedance match stage 414. In one embodiment, the impedance match stage 414 is implemented outside the ASIC to ensure that fine adjustments to the match stage 414 may be made based on the actual input impedance of the transmit/receive switch 412.

The input to the power amplifier 416 comes from a BPSK modulation stage 424, which generally includes a mixer 426 and a codeword modulator 428. The BPSK modulation stage 424 enables the transponder to produce a direct sequence spread spectrum signal, which is used for the locator signal, as is described in detail in later sections. When not using the BPSK modulation stage 424, it acts as a pass through.

The input to the BPSK modulation stage 424 comes from an oscillator select switch 430. In this embodiment, the transponder is provided with two oscillators. One is used in the RTLS system and another is used in for a different application. For example, in the case where the transponder may be used for ETC applications that require detection of a trigger signal from a reader and a relatively quick response by the transponder with a transponder information signal, the crystal-based oscillator and synthesizer 450 used for RTLS may have too slow of a start-up time, in part because this oscillator requires the agility to adjust to selected individual channel frequencies. Accordingly, a second and more simple oscillator may be provided. In one embodiment, the second oscillator provides a fixed pre-determined carrier frequency. In an example, the second oscillator may include an off-chip SAW resonator 432 and integrated UHF SAW oscillator circuit 434. It will be understood that other types of oscillators may be used in those embodiments in which a second oscillator is provided.

The RTLS oscillator includes a crystal 436, such as a watch crystal, together with the crystal oscillator circuitry 438 and a frequency multiplier 430, such as a phase-locked loop (PLL). Together these elements produce a reference frequency signal 442, which is input to the synthesizer 450. The crystal 436 is useful for producing a stable low power low frequency signal. For example, before the frequency multiplier 430, the crystal oscillator circuitry 438 may output a timing signal 444, which in one embodiment is approximately 32 kHz. The low power low frequency timing signal 444 is useful since the transponder is required to measure long timing intervals between broadcasts. Alternatively, the synthesizer 450 may have a separate reference oscillator if spectral requirements demand a higher frequency reference oscillator.

The synthesizer 450 is, in one embodiment, a fractional-N synthesizer. The fractional-N synthesizer 450 receives a frequency shift keyed (FSK) or Gaussian-minimum shift keyed (GMSK) signal from the digital portion of the ASIC. The fractional-N synthesizer 450 functions in known manner to produce a modulated signal at the selected channel frequency when supplied with FSK (GMSK) modulated input. Those ordinarily skilled in the art will appreciate the range of modifications or options available in implementing the synthesizer 450. In addition to producing the modulated signal for transmission, the synthesizer 450 is also configured to produce a frequency reference signal 452 for use in the receiver.

The analog portion of the transmitter 402 may include a third oscillator 460 for producing a digital clock signal 462 that may be used by the digital components of the ASIC. The timing signal 44 from the RTLS oscillator may be to low frequency for the digital portion. The third oscillator 460 may, in one embodiment, be implemented as an RC oscillator. A calibration signal may be input to the RC oscillator for tuning to keep the frequency within required tolerances.

The ASIC may also include a backscatter modulator 470 for use in connection with applications requiring backscatter modulation. The backscatter modulator 470 may be placed on a separate pin, since it may be advantageous to bypass the bandpass filter 408 and connect the backscatter modulator 470 directly to the antenna 406 to ensure maximum reflected signal.

Referring now to FIG. 6B, it will be noted that the receiver portion 404 obtains the frequency reference signal 452 from the synthesizer 450 described in connection with FIG. 6A. The signal from the antenna 406 (FIG. 6A), received through the transmit/receive switch 412 (FIG. 6A), is input to a selector switch 480. The selector switch 480 directs the incoming signal from the antenna 406 to either a channel receiver 480 or a wideband receiver 472.

The channel receiver 480 is configured to downconvert incoming signals on a given channel. The channel receiver 480 may include one or more amplifiers 482a, 482b, 482c, for boosting the signal level at various stages of the downconversion process.

In general, the channel receiver 440 is configured to perform a two step downconversion. The incoming frequency reference signal 452 at the desired channel frequency passes through a frequency divider 484. The halved frequency signal is then input to two mixers 488a, 488b, to perform the two downconversion steps. A first IF filter 486a and a second IF filter 486b may be implemented outside the ASIC. In one embodiment, the second IF filter 486b may be a relatively high frequency bandpass filter, with a center frequency at about 70 MHz. In one embodiment, the second IF filter is implemented as a SAW filter. In some embodiments, one or more of the IF filters 486a, 486b, may be implemented within the ASIC, as indicated by the phantom lines.

After the incoming signal has been downconverted to IF, it is input to a limiting amplifier 490 and, following the limiting amplifier 490 to a data slicer 494. The data slicer 494 outputs a signal that may be input to a digital FSK receiver (not illustrated) within the ASIC. The receiver 404 may also include an analog-to-digital converter (ADC) 492 that takes an output from the limiting amplifier 490 that is indicative of received signal strength intensity. This value may then be input to the digital stage as an RSSI value.

The wideband receiver 472 may be employed for more passive listening for trigger signals or other such broadcasts in connection with other protocols. For example, an ETC protocol may require the transponder to listen for a trigger signal having certain characteristics, following which the transponder sends a response signal.

The wideband receiver 472 may include a passive detector circuit 474, followed by a threshold circuit 476 for sensing signals above a given threshold. A detector match circuit 471 may be used at the input to the passive detector 474 to ensure that the full received signal is input to the wideband receiver 472.

For more sensitive listening, the wideband detector 472 may include an active power receiving portion, such as that illustrated with the comparator 478.

The signal detected and received by the wideband detector 472 may be analyzed by the digital portion of the ASIC to confirm that it meets the criteria of a proper wakeup signal for a given application.

It will be appreciated that the circuits illustrated in FIGS. 6A and 6B are examples only and that the transponder transmitter and receiver circuits may be implemented in a variety of other manners. In one example, the channel receiver 480 may be implemented as a low IF-frequency (or zero IF-frequency) IQ receiver.

Oscillator Drift

As outlined above, the transponder may include a relatively inexpensive watch crystal as the basis for a local oscillator. This reduces the overall cost of the transponders, but can lead to problems with oscillator drift. Drift in the frequency produced by the local oscillator results in inaccuracy in the timing functions performed by the transponder and inaccuracy in the carrier frequency used for transmissions. Accordingly, the interval duration used by the transponder may not be accurate, causing the transponder to broadcast later or earlier than expected by the reader(s) 12. Moreover, the transmission may not be at the centre frequency of one of the channels. Significant drift may cause the transmission to leak across channels, possibly interfering with other transponder or reader transmissions.

In one embodiment, the reader 12 and transponder 16 are configured to determine the oscillator inaccuracy and, in some cases, to correct for it. In particular, the reader 12 may detect the extent of the oscillator drift by detecting the inaccuracy in the transponder 16 calculation of an interval time. The transponder 16 is instructed by the reader 12 to send two sequential transmissions with a known interval between the transmissions. The transmissions may be regularly scheduled identification transmission or may be specific oscillator testing transmissions. The reader 12 measures the difference between the arrival times of the two transmissions and compares that difference to the interval time. Based on the discrepancy the reader 12 may determine the extent of the oscillator drift.

By way of example, a transponder with a 50 ppm tolerance and a required time interval of 30 minutes may have a transmission that occurs up to 90 milliseconds early or late. Such a discrepancy may be too large for collision avoidance in the scheduling of in-network transponder 16 transmissions.

In one embodiment, the reader 12 attempts to account for the deviation in the local oscillator by adjusting the interval time communicated to the transponder 16. In one case, the reader 12 may simply determine an adjusted interval time that corrects for the oscillator drift and may communicate the adjusted interval time to the transponder 16. In another case, the reader 12 may determine the number of oscillator cycles needed to achieve a certain interval time given the drift in this transponder's oscillator, and may communicate this number of cycles to the transponder 16. The transponder 16 then need only count the appropriate number of cycles. In yet another case, the reader 12 may simply report the desired interval time and the discrepancy information to the transponder 16, and the transponder 16 may perform the function of adjusting the interval time to compensate for its oscillator drift.

The reader 12 and transponder 16 may also attempt to correct the transmission frequencies to account for oscillator drift. A fractional-N synthesizer allows for fine step frequency tuning. If the steps are fine enough, then adjustments may be made to account for oscillator drift based on the time discrepancy measured by the reader 12. This permits more precise channel allocation, more accurate demodulation by the readers 12, and, potentially, closer channel spacing.

The oscillator drift analysis may be performed in combination with the “stutter step” transmission protocol outlined above for out-of-network transponders 16. In this embodiment, the duration interval between two sequential transmissions of about one minute is sufficiently long for the assignment of a master reader and the calculation in the reader of an adjustment to the interval duration and/or the codeword for frequency synthesis. Following the second transmission, the reader 12 is capable of communicating with the transponder 16 to place it in-network, including communication of the node ID, compensated interval time, and compensation value for the transmission frequency, if necessary.

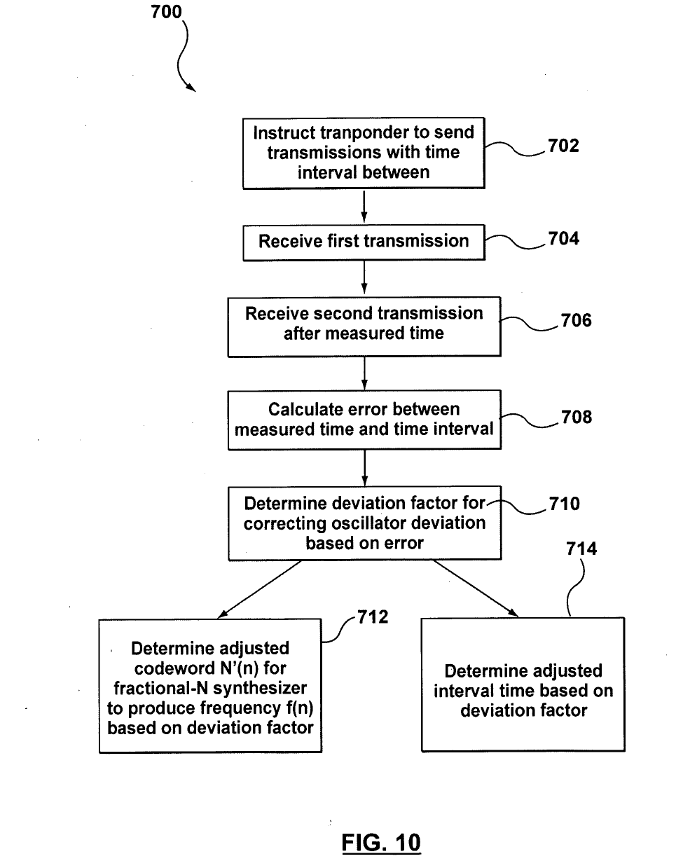

Reference is now made to FIG. 10, which shows, in flowchart form, a method 700 of correcting for oscillator drift in a transponder. The method 700 begins with step 702, in which the transponder is instructed to send transmissions with a predetermined time interval between them. The instruction may come from the reader as part of the registration process placing the transponder “in-network”. Alternatively, it may occur as part of a periodic process for detecting oscillator drift with in-network transponders. The predetermined time interval may be communicated as part of the instruction or may be a predetermined interval programmed into the transponder and known to the reader. The predetermined time interval may simply be the interval duration assigned by the reader as a normal part of the identification process.

In step 704, the transponder sends and the reader receives the first transmission. The transponder then monitors the time elapsed since the first transmission. The time elapsed may be monitored using a counter, and alarm function, or other trigger for determining when the predetermined time interval has elapsed. The reader also monitors the time elapsed since receipt of the first transmission. The reader includes a clock circuit having a more expensive and sophisticated oscillator that is likely to result in a more accurate time base.

Once the transponder determines that the predetermined time has elapsed, it sends the second transmission. The reader receives the second transmission as indicated in step 706. In step 708, the reader determines the time elapsed between receipt of the first transmission and the second transmission and compares this time with the predetermined time interval. The difference between the two, if any, represents the error resulting from inaccuracies in the transponder clock. The reader may be configured to ignore any error below a threshold level on the basis that it does not amount to a significant error.

Having determined the error between the time calculated by the transponder and the predetermined interval time, the reader then calculates a deviation factor for correcting the oscillator deviation at the transponder, as shown in step 710. The deviation factor may, in some embodiment, be a signed error. In some embodiments, the deviation factor may be an extra a number of clock cycles per some time unit. Other forms for representing the correction required will be appreciated by those skilled in the art.

In some embodiments, the deviation factor may be used to adjust the frequency generated by the transponder. This embodiment is reflected in steps 712, wherein the deviation factor is used to determine an adjusted codeword for use in the fractional-N synthesizer. Normally, the desired frequency would be associated with a codeword. The error in the oscillation clock results in generation of a frequency different from the desired frequency using the associated codeword. This deviation is corrected by adjusting the codeword such that the inaccurate oscillation clock and adjusted codeword result in production of the desired frequency. The deviation factor and the desired frequency determine the adjustment to the codeword.

Step 712 may be partly implemented at the reader. In one embodiment, the reader determines the adjusted codeword and communicates it to the transponder. In another embodiment, the reader determines the quanta of adjustment to be made, communicates the adjustment, and the transponder adds or subtracts (as the case may be) the quanta of adjustment from the unadjusted codeword. In yet another embodiment, the reader supplies the deviation factor to the transponder, and the transponder calculates the adjusted codeword itself.

In some embodiments, the deviation factor may be used to adjust or correct the interval time or duration monitored by the transponder for the next transmission. This embodiment is reflected in step 714. Step 714 includes calculating an adjusted interval time based on the deviation factor. For example, if the deviation factor indicates the oscillator clock on the transponder is 0.25% fast, then timing word for next interval needs to be increased with 0.25%.

Locate Operation

In addition to identifying transponders 16, the system 10 is configured to locate individual transponders 16.

There are two basic approaches to locating transponders 16. Each requires that the transponder 16 and a plurality of readers 12 exchange communications. The first approach is to determine the received signal strength intensity, RSSI, which can then be used to determine the relative distance of the transponder 16 from various readers 12. In some embodiments, the transponder 16 may determine the RSSI of reader transmissions; however, it is more common to have the readers 12 determine the RSSI of a transponder 16 transmission.

The second approach is to use time-of-arrival (TOA) calculations. By determining the relative difference in time of arrival of the communications between various readers 12 and the transponder 16, one may determine the relative distances between the transponder 16 and the various readers 12. In some embodiments, TOA measurements may be based on the time a transponder transmission arrives at various readers 12. In other embodiments, TOA measurements may be based on the travel time of reader 12 transmissions to the transponder 16.

The present system 10 may employ aspects of both approaches in various embodiments. For example, some embodiments may employ both TOA and RSSI measurements to achieve improved accuracy in locating the transponders 16.

The determination as to when a transponder 16 should be located may be based on an algorithm that attempts to ensure each transponder 16 is located on a periodic basis. The algorithm may take into account whether the transponder 16 has been recently moved or whether it has remained stationary for a long period of time to determine how often the location of the transponder 16 should be checked. In some cases, the location function is one triggered on request of a user of the system 10. For example, a request to locate a given item may result in the system 10 performing a locate function on the transponder associated with the item.

RSSI-Based Location of Transponders

In an embodiment in which RSSI is employed, the transponder 16 broadcasts a locator signal that is received by various readers 12. The readers 12 each record the RSSI of the received locator signal and report the RSSI to the master reader 12 or to the host 14.

In some embodiments, the transponder 16 may send the locator signal within a single channel. However, multipath and other environmental impacts on the locator signal 16 can render the RSSI values unreliable. To improve the RSSI values, in some embodiments, the transponder 16 employs direct sequence spread spectrum (DSSS) to send a wideband locator signal. The readers are equipped with DSSS wideband receivers, i.e. de-spreaders, to permit reception of the DSSS locator signal. Multipath and other environmental degradation is often not consistent across frequencies, meaning that the impact of these environmental factors on the signal strength of the overall DSSS signal across its full spectrum may be less significant than with a single channel locator signal. This may result in more accurate RSSI calculations using DSSS locator signals.

In one DSSS embodiment, the transponder 16 may include a binary phase shift keying (BPSK) modulator with the modulation signal itself being the direct chip sequence to achieve a DSSS locator signal. Advantageously, in-channel transmission may still be accomplished using this modulator by replacing the direct sequence by a constant signal.

The RSSI values measured by the readers 12 may be used to calculate relative distances between the transponder 16 and the readers 12. As noted above, RSSI values may also be calculated in connection with the identification message in order to identify which readers 12 will participate in the locating function and which of those readers 12 will act as the “master reader”. The master reader and “slave” readers are then the readers 12 that participate in the location function.

The transponder 16 broadcasts its DSSS locator signal when instructed to do so by its master reader. In one embodiment, the code sequence used in the DSSS is a fixed word, which allows all receivers to use only that word thereby simplifying the receiver design. The host 14 may participate in scheduling a locator signal such that no overlapping in-network identification messages are scheduled for the same timeslot in the vicinity of the transponder 16. Alternatively, the host 14 may simply ensure that no other locator signals are scheduled for the same timeslot, which removes the need for use of different codes. In some embodiments, time slots may be further divided into two parts, one for identification communications, and one of locator functions, so as to avoid collisions between identification messages and locator signals.

In another embodiment, the code word may be a word chosen by the host and forwarded to the master reader and slave readers and to the transponder 16. In such an embodiment, it would be possible for multiple transponders in distinctive locations to transmit temporally overlapping locator signals. Transponders may be considered in “distinctive” locations if the processing gain achieved for these transponders is sufficient to have them be distinguished by one set of receivers versus another set. In practical terms, this permits temporally overlapping locator signals from transponders that are closer together than would be permitted in the case of a single code word.

In one alternative embodiment, instead of using DSSS technology, the locator message may be repeated in a multitude of channels. Averaging and/or comparison of RSSI values for each channel may reduce the impact of multipath on the accuracy of the location function. This may reduce the cost of equipping each receiver with a de-spreader; however, the requirement to retransmit the message in a multitude of channels may result in the locator function occupying the readers 12 and channels for a longer period of time to accomplish the locator function.

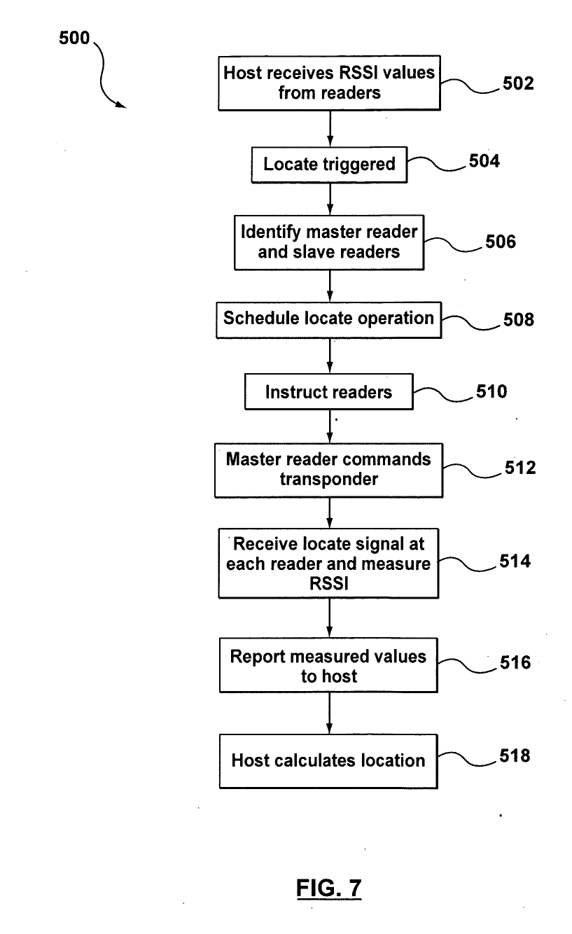

Reference is now made to FIG. 7, which shows, in flowchart form, an RSSI-based method 500 for locating a transponder. It will be appreciated that this method 500 may be used in conjunction with other methods, like TOA, to more accurately determine the location of the transponder.

The method 500 begins in step 502. In step 502, the host receives RSSI values recorded by various readers based on reception of the transponder's identification message. The transponder may be placed “in-network” and assigned a node-ID. The receipt of RSSI values measured from received identification messages may occur more than once as the transponder periodically broadcasts its identification signal. To reduce reader-to-host traffic, the readers may only report RSSI-values to the host if they differ by a threshold amount from the RSSI-value previously recorded for that transponder.

In step 504, a locate operation is triggered with respect to the transponder. The locate operation may be triggered based on a time elapsed since a previous locate operation for that transponder. It may be triggered based on detection of RSSI-values from the identification message that are significantly different from those recorded earlier, which may indicate movement of the transponder. In some instances, a different set of readers may receive the identification message than received an earlier identification message, which may indicate that the transponder has moved to a new area. The locate operation may also be requested by a user, either by inputting a request for the location of the transponder and/or the item with which it is associated, or requesting the location of a category of items or transponders.

In step 506, the host identifies the master reader and slave readers for participation in the locate operation based on the RSSI values reported during identification. The step 506 may have occurred earlier in the sequence on receipt of the RSSI values. The master reader is generally the reader that received the strongest identification signal from the transponder. The slave readers may include three or more additional readers. For example, the slave readers may include the three readers that recorded the next strongest RSSI values on receipt of the identification signal. The slave reader may include all those readers that recorded an RSSI value over a threshold, up to a defined maximum. For some embodiments, the slave readers may include a minimum of two or three readers in addition to the master reader, depending on the algorithm being used to locate the transponder.

The host schedules the locate operation in step 508. The timing of the locate operation may be partly based on when other locate operations are scheduled so as to prevent overlapping locator signals in the same area.

In step 510, the host sends instructions to the master reader and slave readers to perform a locate operation with respect to the transponder. The instructions may include the scheduled timeslot for the locate operation. The scheduling of the locate operation may take into account the fact that the master reader will await broadcast of the transponder's identification signal before responding with a command instructing the transponder to send a locate signal. Thus, the scheduled timeslot should be after the next anticipated/scheduled broadcast of the transponder's identification signal. The master reader sends the locate command to the transponder in step 512. In some embodiments, the command may include the code word to be used in generating the locate signal in the case where DSSS is used. In some embodiments where DSSS is used, the code word may be a fixed word known to each of the readers and transponders.

In step 514, the transponder broadcasts the locate signal. The master reader and each slave reader receives the locate signal and records the RSSI for the signal. In step 516, the master reader and the slave readers each report their respective RSSI values to the host. In step 518, the host then determines the location of the transponder based on the RSSI values reported by the readers participating in the locate operation. Using the known location of the readers and the relative RSSI values reported by the readers, the host may calculate the probable location of the transponder.

The location of each reader is predetermined and known to the host. On installation, the physical location of each reader may be manually determined and input to the system. In some embodiments, the physical location of a subset of readers is manually determined and input to the system and the location of additional readers is determined using a modified locate operation.

In an alternative RSSI-based location operation, the transponder may be configured with a de-spreader to enable receipt of DSSS messages from the readers. In such an embodiment, each of the participating readers broadcasts a DSSS locate message to the transponder, and the transponder records the RSSI values for each message. The transponder reports these recorded RSSI values to the master reader, which then relays them to the host, and the host determines the location of the transponder based on the relative strength of the RSSI values recorded by the transponder for each of the participating readers.

In yet another alternative embodiment, both the readers and the transponders are configured to send and receive DSSS messages. The data from reader detection of a transponder locate message is combined with data from transponder recordal of DSSS messages from the readers to locate the transponder with improved accuracy.

TOA-Based Location of Transponders

In a TOA-based embodiment, the location of a transponder is calculated by determining the relative distance from the transponder to each of a set of readers. This is accomplished by determining the relative travel time of a signal from the transponder to each of the readers. The differences in time-of-arrival between respective readers corresponds to the differences in distance between the respective readers and the transponder. In other words, the time delay between arrival of the transponder's locate signal at a first reader versus a second reader leads to definition of a hyperbola bisecting the readers. With a third reader, additional hyperbolas may be produced. The location where the hyperbolas intersect defines the probable location of the transponder.

A difficulty encountered by time-of-arrival systems for determining location is synchronizing all the readers so that they are operating from a common time base. Another difficulty is that each reader includes receiver circuitry, filters, etc., that contributes delay to recordal of a reception time. This delay, because it is not identical in all readers/receivers, results in inaccuracies in the location calculation.

In one aspect, the present application provides a method and system for determining the location of a transponder that eliminates synchronization and receiver delay problems.

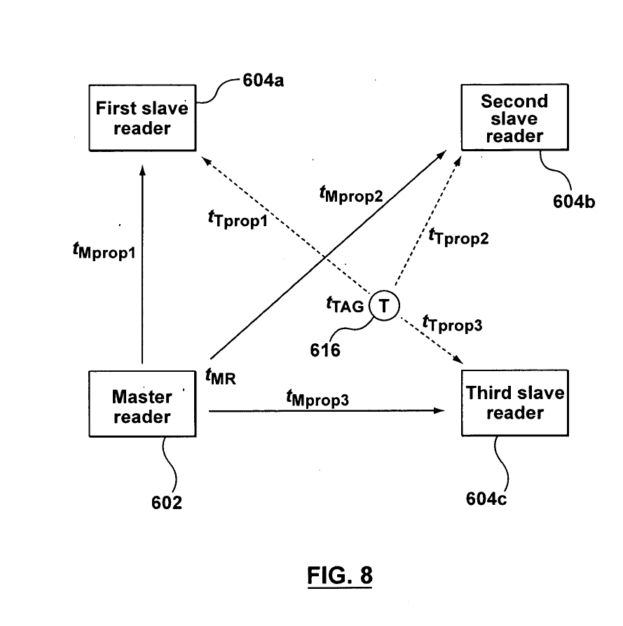

Reference is now made to FIG. 8, which diagrammatically shows an RTLS system 600 for performing a TOA location operation. The system 600 includes a transponder 616 and at least four readers. As noted previously, based on the RSSI values recorded by various readers receiving an identification signal, a host (not shown) assigns a master reader 602 and at least three slave readers 604 (shown individually as 604a, 604b, 604c).

As discussed above in connection with FIG. 7, when a locate operation is triggered, the host instructs the master reader 602 and the master reader 602 sends a locate command to the transponder 616. The host may instruct the slave readers 604 or may leave it to the master reader 602 to instruct the slave readers 604.

The transponder 616 responds to the locate command by sending its locate signal at or near the scheduled time. The locate signal may be a DSSS signal or may be a single channel transmission. In some embodiments, the readers 602, 604 may also record RSSI values to provide additional information to improve the determination of location.

Each of the slave readers 604 receives the transponder locate signal and records the time of receipt. The time of receipt at each of the slave readers may be expressed as:

t_{TAG@1}=t_{TAG}+t_{Tprop1}+t_{rec1}

t_{TAG@2}=t_{TAG}+t_{Tprop2}+t_{rec2}

t_{TAG@3}=t_{TAG}+t_{Tprop3}+t_{rec3}

where t_{TAG} is the time at which the transponder 616 sends the transponder locate signal, t_{Tpropn} is the travel time from the transponder 616 to the respective reader 604, and t_{recn} is the time delay in the receiver circuitry of the respective reader 604.

Following receipt of the transponder locate signal the master reader 602 broadcasts a master locate signal. Each of the slave readers 604 records the time of receipt of the master locate signal. The time of receipt of the master locate signal at each slave reader 604 can be expressed as:

t_{MR@1}=t_{MR}+t_{Mprop1}+t_{rec1}

t_{MR@2}=t_{MR}+t_{Mprop2}+t_{rec2}

t_{MR@3}=t_{MR}+t_{Mprop3}+t_{rec3}

where t_{MR} is the time at which the master reader 602 sends the master locate signal, t_{Mpropn} is the travel time from the master reader 602 to the respective slave reader 604, and t_{recn} is the time delay in the receiver circuitry of the respective slave reader 604.

Accordingly, each slave reader 604 has an accurate measurement of the delay, t_{M-T,n}, between its reception of the transponder locate signal and the master locate signal. For each of the slave readers 604, this delay may be expressed as:

$$\begin{matrix}{t}_{M - T , n} = {t}_{MR @ n} - {t}_{TAG @ n} \\ = {t}_{MR} + {t}_{Mpropn } + {t}_{recn} - ( {t}_{TAG} + {t}_{Tpropn} + {t}_{recn} ) \\ = {t}_{MR} + {t}_{Mpropn} - {t}_{TAG} - {t}_{Tpropn}\end{matrix}$$

Note that the receiver delay advantageously cancels from the equation since it is the same for receipt of the transponder locate signal and the master locate signal. Each of the slave readers 604 reports the delay value, t_{M-T,n}, to the host. In some embodiments, they may relay the delay values to the master reader 602, which then sends the delay values to the host. In yet other embodiments, they may simply send the delay values to the master reader 602, which may the perform the analysis described below. The master reader 602 may send location information to the host once it has been calculated. In some cases, the master reader 602 may only send the host location information for a transponder if it has changed significantly since a previous report, thereby reducing the communications network load. In any event, based on these measured delay values the host or master reader may determine the location of the transponder, as outlined below.

The difference, Δt_{xy}, between the delay values at slave reader x and slave reader y may be expressed as:

$$\begin{matrix}Δ {t}_{xy} = {t}_{M - T , x} - {t}_{M - T , y} \\ = {t}_{MR} + {t}_{Mpropx} - {t}_{TAG} - {t}_{Tpropx} - ( {t}_{MR} + {t}_{Mpropy} - {t}_{TAG} - {t}_{Tpropy} ) \\ = {t}_{Tpropy} - {t}_{Tpropx} + {t}_{Mpropx} - {t}_{Mpropy}\end{matrix}$$

The host can calculate the difference, Δt_{xy}, based on the reported delay values, t_{M-T,x} and t_{M-T,y}, from the slave readers 604. The expression above may be rearranged as:

t_{Tpropy}−t_{Tpropx}=Δt_{xy}−t_{Mpropx}+t_{Mpropy}

Because it knows the reader coordinates and, thus, the distances between the master reader 602 and the slave readers 604, the host may calculate the travel times t_{Mpropx} and t_{Mpropy} from the speed of signal propagation, c, and the distances from the master reader 602 to the respective slave readers 604. Accordingly, the host may determine the quantity t_{Tpropy}−t_{Tpropx}, which reflects the difference in propagation time from the transponder 616 to the respective slave readers 604. From this determined quantity, the host can calculate a differential distance between the two readers 604 relative to the transponder 616 as:

Δd_{TAGxy}=(t_{Tpropy}−t_{Tpropx})×c

This value defines a hyperbola between the two readers 604. Mathematically, it defines two curves; however, the sign of the value Δd_{TAGxy} may be used to select one of the curves.

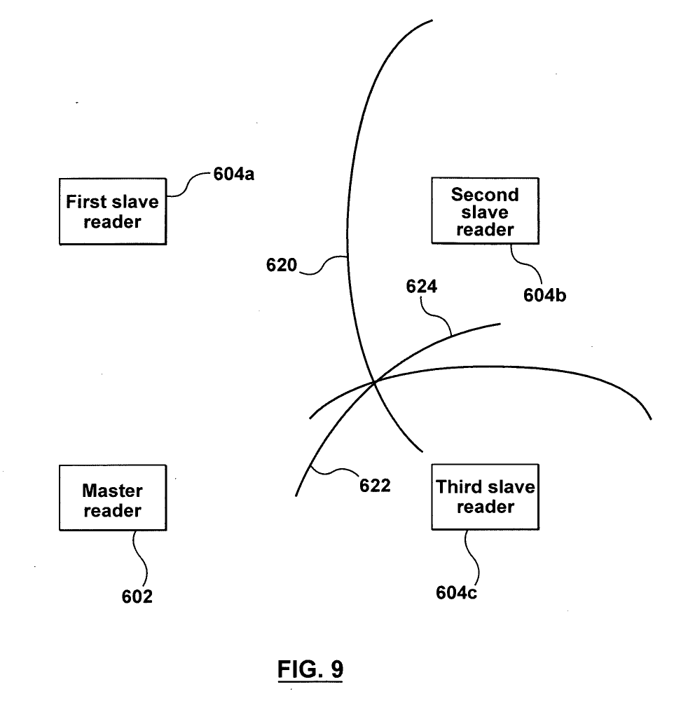

Using three slave readers 604, the host can define three hyperbolas. The location where all three hyperbolas intersect determines the location of the transponder 616. FIG. 9 shows the system 600 of FIG. 8 with the calculated hyperbolas from a location operation illustrated graphically. The hyperbolas include a first hyperbola 620 defined based on the relative reception times recorded in the first slave reader 604a and the second slave reader 604b; a second hyperbola 622 defined based on the relative reception times recorded in the second slave reader 604a and the third slave reader 604c; and a third hyperbola 624 defined based on the relative reception times recorded in the third slave reader 604c and the first slave reader 604a.

If points of intersection between the three or more hyperbolas are not exactly aligned, one mechanism is to geographically average the intersection locations to determined a transponder location. Another mechanism is to select a best intersection based on the relative angles at which the hyperbolas intersect. For example, hyperbolas that intersect close to 90 degrees are more likely to produce an accurate location than hyperbolas that intersect at shallow angles. In one embodiment, a weighted averaging may be employed, where those intersections at angles close to 90 degrees are given a heavier weighting in the averaging operation than those intersections at shallower angles. Other mechanisms of determining the location from the relative distances will be appreciated.

In some instances, such as where a transponder 616 is located near the edge of the coverage area, such that the readers 604 do not substantially surround the transponder 616, two valid intersections may result. In some such instances, additional information, including RSSI values may be used to determine the proper intersection.

It will be appreciated that more than three slave readers may be used to improve accuracy.

Although the above embodiment presumes that the master reader 602 sends its master locate signal after the transponder 616 sends its transponder locate signal, in other embodiments the master locate signal may be sent before the transponder locate signal.

In some embodiments, the system may include simplified readers intended for short-range localization. These simplified readers may be referred to as beacons or signposts. The simplified reader may include a transmitter for sending messages to transponders and/or readers. The simplified reader may include a receiver for receiving transponder locate signals. For example, the receiver may be configured to receive DSSS locate signals and provide TOA data to the master reader and/or host for use in localization operations. Because the receiver does not require channel scanning capabilities, it may be a simplified and less costly receiver. It may also be less sensitive and thus lower cost since it is intended for shorter read range. Accordingly, less costly simplified readers may be deployed in areas of higher concentration of transponders for which more accurate localization is desirable, but for which additional full-capacity reader are not necessary for the identification function.

The simplified readers may also be positioned at points of egress or ingress to the coverage area. Using a transmitter, the simplified short-range reader may detect transponders in the immediate area using an identification function, which may indicate which transponders are likely entering or leaving the coverage area. This data may be useful to the host in scheduling location operations or other activities.

In one embodiment the short-range communication with the transponder may rely on the wideband receiver in the transponder. The transponder may be configured to distinguish the transmission by the simplified reader from other wideband signals. This permits operation of this functionality asynchronously from the normal transmission and listen cycle of the transponder. The wideband reception of a transmission from a simplified reader may trigger a transponder response in a selected channel. The channel may be preconfigured or may be identified in the transmission from the simplified reader.

In yet another embodiment, the simplified reader is based on the ASIC used in the transponders with a reduced beacon transmit power. Such an ASIC may implement all necessary functionality to emulate a reader-type device with the distinction that it has reduced transmission power which is suitable for short range communication.

Multi-Protocol Architecture

As noted above, the ASIC for the transponder may be configured to function in other systems using other protocols. For example, using its passive or low power wide-band detector, the transponder may be adapted to respond in accordance with an electronic toll collection (ETC) protocol for performing automated vehicle identification and toll payment. In another example, using the passive detector the transponder may be adapted to respond in accordance with one of the Electronic Product Code (EPC) protocols, such as EPC Class 1 Generation 2. The ASIC and transponder may be configured to detect transmissions and, in some cases, respond in accordance with other possible communications protocols.

In one embodiment, the ASIC is configured to operate in accordance with one of the available protocols. Based on configuration data input to the ASIC in a configuration step, the ASIC is adapted to operate in the identification/location system or in accordance with another protocol, such as an EPC or ETC protocol.

In another embodiment, the ASIC is configurable to operate in both modes and is capable of detecting and responding to communications using different protocols.

The transponder may include a signal bus that makes available signals from the receiver and the detector, and also provides access to the transmitter. The transponder may, in some embodiments, also have a backscatter transmitter available through the signal bus. The use of the signal bus permits inclusion of a microprocessor or other processing hardware outside of the ASIC to implement the processing associated with other protocols not pre-established in the ASIC. The signal bus thus provides a mechanism for allowing external devices to have access to the ASIC hardware. In this manner the transponder is adaptable to support new or evolving protocols without requiring a redesigned ASIC.

The detection and response to EPC protocol communications may allow for the detection and signaling of EPC activity from the transponder to one of the readers in the identification/location system. This may permit “sign-post” functionality, in that the transponder would report that it is in close proximity to an EPC transmitter. If the locations of EPC transmitters are known to the host, it may deduce the location of the transponder. The transponder may be configured to ignore the EPC signals on instruction from the host to avoid continuous EPC signaling by the transponder if it is stationary in the vicinity of an EPC transmitter.

EPC does not normally provide reader identifiers within an EPC transmission. In the case where multiple EPC readers/transmitters are present, it may be advantageous to have a mechanism for identifying which EPC transmitter the transponder has detected. Otherwise, the host may be unable to determine whether the transponder is near one EPC transmitter or another. In the EPC protocols, a “mask” field is defined within the select command for instructing only certain tags to respond. The EPC transmitters within the system may be configured to mimic the sending of a reader node ID by using this mask. The transponders may be configured to detect and report the reader node ID encoded into the mask field of a select command, and thus, to identify the EPC reader from which it received a transmission.

The EPC protocol may further be exploited to permit short-range programming of the transponder. The transponder may be configured to detect and treat EPC protocol communications as configuration instructions. In other words, a system administrator or other user may be able to access the transponder memory for programming and configuration purposes using a short-range handheld EPC reader.

In yet another embodiment, in addition to or in the alternative to use of the EPC protocol, the transponder may be configured to be programmable using one of the 13.56 MHz protocols.

Reader Authentication

Referring again to FIG. 1, the real-time location system 10 includes a number of readers 12 that communicate with transponders 16 and with the host 14. The host 14 may typically be connected to an enterprise system (not shown) via an interface to supply data to the enterprise system. For example, data from the system 10 may be integrated with an inventory database in the enterprise system or may be used for other purposes. The interface and the enterprise system may take a multitude of forms and may be for any number of purposes.

One way for a malicious person to attack the enterprise system may be through the real-time location system 10. A malicious attack may come through spoofing a reader 12, for example, and supplying the host with false data. Other attacks might also be devised.

In order to protect the integrity of the system 10, it may be advantageous to incorporate authentication mechanisms to ensure that readers 12 can be authenticated as legitimate.

In one embodiment, each reader 12 must perform a registration operation when first introduced to the system 10. Authentication may take place in-band within the spectrum for identification and location messaging.

In one embodiment, the authentication is based on a message history. For example, the host may determine a first message and a total number of messages to be included in a set for the authentication operation. The authentication process is based on a checksum that is determined using all the messages in the set. At the end of the set of messages, the checksum together with the reader ID and a challenge from the host are used to calculate a verification number using a unique and secret function. When queried by the host 14, the reader 12 calculates the verification number and sends it to the host 14. The host 14 then verifies the accuracy of the number to authenticate the reader 12.

In such an embodiment, the host 14 indicates the first message to be included in the set. Thereafter, the reader 12 continually updates its checksum value for each message until the host requests a reset again or until the host requests an authentication calculation.

After the last message to be included, the host may request the authentication calculation. The fact that authentication is optional and is based on a cumulative checksum over a number of regular-course messages minimizes the impact of the authentication on network traffic. The checksum may be a simple sum of all data bytes or may involve more complicated algorithms.

The authentication calculation to produce the verification number is based on a secret algorithm pre-programmed into each reader 12 and the host 14. Accordingly, this algorithm may be stored in firmware in the devices and may be placed in a protected portion of memory to prevent unauthorized access.

The authentication calculation algorithm has sufficient complexity to ensure the three input numbers, checksum, node ID, and challenge, cannot be derived from the result. The challenge number may be a random number generated by the host 14.

Certain adaptations and modifications of the invention will be obvious to those skilled in the art when considered in light of this description. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of determining location of a transponder in a locating system, the system including a plurality of spaced-apart stationary readers having known locations, one of the readers being designated as a master reader with respect to the transponder and at least three of the readers being designated as slave readers with respect to the transponder, the method comprising:
broadcasting a transponder locate signal from the transponder;
broadcasting a master locate signal from the master reader;
detecting the master locate signal and the transponder locate signal at each of the slave readers and measuring a delay time between time of receipt of the two signals;
calculating a first differential distance between a first one of the slave readers and a second one of the slave readers and the transponder based on the measured delay times at the first and second slave readers, wherein the first differential distance defines a first hyperbola;
calculating a second differential distance between the first one of the slave readers and a third one of the slave readers and the transponder based on the measured delay times at the first and third slave readers, wherein the second differential distance defines a second hyperbola; and
determining a likely location of the transponder based on a point of intersection between the first and second hyperbolas.

2. The method claimed in claim 1, further including calculating a first-second delay difference as the difference between the delay time measured at the first slayer reader and the delay time measured at the second slave reader, and calculating a second-third delay difference as the difference between the delay time measured at the second slayer reader and the delay time measured at the third slave reader.

3. The method claimed in claim 2, wherein calculating a first differential distance comprises determining a first differential travel time of the transponder locate signal from the transponder to the first and second slave readers and multiplying by a speed of radio propagation, and wherein the first differential travel time is determined by subtracting a first differential master propagation time from the first-second delay difference, wherein the first differential master propagation time comprises the difference in travel time of the master locate signal from the master reader to the first and second slave readers.

4. The method claimed in claim 3, further including determining the difference in travel time of the master locate signal from the master reader to the first and second slave readers by determining the distance between the first slave reader and the master reader and the distance between the second slave reader and the master reader from based on their known locations, and dividing by the speed of radio propagation.

5. The method claimed in claim 1, further including calculating a third differential distance between the second one of the slave readers and the third one of the slave readers and the transponder based on the measured delay times at the second and third slave readers, wherein the third differential distance defines a third hyperbola.

6. The method claimed in claim 5, wherein determining a likely location of the transponder includes finding the points of intersection between the three hyperbolas, and geographically averaging said points of intersection.

7. The method claimed in claim 5, wherein determining a likely location of the transponder includes determining an angle of intersection between each pair of the three hyperbolas, and wherein the determination of the likely location is based upon at said angles of intersection.

8. The method claimed in claim 1, further including measuring a signal strength of the transponder locate signal at each of the readers, and wherein determining a likely location of the transponder includes determining the likely location based partly on the point of intersection between the first and second hyperbolas and partly on the relative signal strength measurements at each of the readers.

9. A real-time location system, comprising:
at least one transponder, the transponder including an antenna, a transceiver, a controller, a power source and memory;
a plurality of spaced-apart stationary readers having known locations, one of the readers being designated as a master reader with respect to the transponder and at least three of the readers being designated as slave readers with respect to the transponder; and
a locator processor and locator memory in communication with the plurality of spaced-apart stationary readers, the memory storing a locator module configuring the processor to determine a likely location of the transponder,
wherein the transponder is configured to broadcast a transponder locate signal,
wherein the master reader is configured to broadcast a master locate signal,
wherein each of the slave readers is configured to receive the master locate signal and the transponder locate signal and measure a delay time between time of receipt of the two signals, and to report the delay time to the locator module,
and wherein the locator module is configured to
calculate a first differential distance between a first one of the slave readers and a second one of the slave readers and the transponder based on the measured delay times at the first and second slave readers, wherein the first differential distance defines a first hyperbola,
calculate a second differential distance between the first one of the slave readers and a third one of the slave readers and the transponder based on the measured delay times at the first and third slave readers, wherein the second differential distance defines a second hyperbola, and
determine the likely location of the transponder based on a point of intersection between the first and second hyperbolas.

10. The system claimed in claim 9, wherein the locator module is further configured to calculate a first-second delay difference as the difference between the delay time measured at the first slayer reader and the delay time measured at the second slave reader, and calculate a second-third delay difference as the difference between the delay time measured at the second slayer reader and the delay time measured at the third slave reader.

11. The system claimed in claim 10, wherein the locator module is configured to calculate a first differential distance by determining a first differential travel time of the transponder locate signal from the transponder to the first and second slave readers and multiplying by a speed of radio propagation, and wherein the locator module is configured to determine the first differential travel time by subtracting a first differential master propagation time from the first-second delay difference, wherein the first differential master propagation time comprises the difference in travel time of the master locate signal from the master reader to the first and second slave readers.

12. The system claimed in claim 11, wherein the locator module is configured to determine the difference in travel time of the master locate signal from the master reader to the first and second slave readers by determining the distance between the first slave reader and the master reader and the distance between the second slave reader and the master reader from based on their known locations, and dividing by the speed of radio propagation.

13. The system claimed in claim 9, wherein the locator module is configured to calculate a third differential distance between the second one of the slave readers and the third one of the slave readers and the transponder based on the measured delay times at the second and third slave readers, and wherein the third differential distance defines a third hyperbola.

14. The system claimed in claim 13, wherein the locator module is configured to determine the likely location by finding the points of intersection between the three hyperbolas, and geographically averaging said points of intersection.

15. The system claimed in claim 13, wherein the locator module is configured to determine an angle of intersection between each pair of the three hyperbolas, and wherein the determination of the likely location is based upon at said angles of intersection.

16. The system claimed in claim 9, wherein each of the readers is further configured to measure a signal strength of the transponder locate signal, and wherein the locator module is configured to determine the likely location of the transponder based partly on the point of intersection between the first and second hyperbolas and partly on the relative signal strength measurements at each of the readers.

17. The system claimed in claim 9, wherein the locator processor and locator memory are implemented within the master reader.

18. The system claimed in claim 9, wherein the locator processor and locator memory are implemented within a host system, and wherein the system further includes a host-reader communications network interconnecting the host system and the readers.

19. A real-time location system, comprising:
a plurality of stationary readers; and
at least one transponder, the transponder including an antenna, a transceiver, a controller, a power source and memory, the memory containing a unique transponder identification number;
wherein the transponder includes a broadcast module configured to broadcast an RF transponder signal containing the transponder identification number when the transponder is in an out-of-network state,
wherein the transponder includes a program module configured to receive RF commands from one of the readers, and wherein the program module is configured to transition the transponder to an in-network state on reception of a command signal assigning a node identification number to the transponder, and wherein the broadcast module is configured to broadcast the RF transponder signal containing the node identification number instead of the transponder identification number when the transponder is in the in-network state,
and wherein the node identification number is shorter in length than the transponder identification number.

20. A method for compensating for an oscillator error in a transponder, the transponder being adapted for use in a real-time location system including at least one reader, the method comprising:
providing transponder with predetermined time interval between transmissions;
receiving a first transmission from the transponder;
receiving a second transmission from the transponder after a time measured by the at least one reader;
determining a difference between the measured time and the predetermined time interval;
determining the oscillator error based on the difference and calculating a deviation factor for correcting the oscillator error; and
applying the deviation factor at the transponder to correct the oscillator error.
